(19) United States
(12) Patent Application Publication
(10) Pub. No.: US 2009/0160792 A1
(43) Pub. Date: Jun. 25, 2009

(54) PORTABLE DEVICE

(75) Inventors: Toshihiro Morohoshi, Kawasaki-shi (JP); Hidehito Izawa, Hanno-shi (JP); Yasukazu Ohno, Ome-shi (JP); Shigeo Morimoto, Hamura-shi (JP); Kazuhiro Takashima, Tokyo (JP); Kenji Koyano, Hanno-shi (JP); Masao Iwasaki, Ome-shi (JP); Tatsuo Hirose, Hamura-shi (JP); Atsushi Nakamura, Hamura-shi (JP); Seiko Kawashima, Ome-shi (JP); Yasuhiro Takahashi, Ome-shi (JP)

Correspondence Address: KNOBBE MARTENS OLSON & BEAR LLP, 2040 MAIN STREET, FOURTEENTH FLOOR, IRVINE, CA, 92614, US

(73) Assignee: KABUSHIKI KAISHA TOSHIBA, Tokyo (JP)

(21) Appl. No.: 12/249,751

(22) Filed: Oct. 10, 2008

(30) Foreign Application Priority Data
Dec. 21, 2007 (JP) 2007-331087

(51) Int. Cl. G06F 3/041

(52) U.S. Cl. 345/173

(57) ABSTRACT

According to one embodiment, a portable device includes a casing, a display contained in the casing and having a first side in proximity to a position of the casing which is held by a user with a hand, a plurality of icons displayed on the display, a touch panel which is provided over the display and by which the icons are operated, and a sensor which is provided in the casing and senses the position held by the user. The icons are arranged in a first area defined by an arc of a circle about a first corner as a center located at a lower end of the first side, and chords extending between the arc and the first corner.

### CROSS-REFERENCE TO RELATED APPLICATIONS

This application is based upon and claims the benefit of priority from Japanese Patent Application No. 2007-331087, filed Dec. 21, 2007, the entire contents of which are incorporated herein by reference.

### BACKGROUND

1. Field

One embodiment of the present invention relates to a portable device, which can store or play back music data or image data.

2. Description of the Related Art

Jpn. Pat. Appln. KOKAI Publication No. 2006-107092 discloses a portable information processing device, which has an operation mode to move a current display area of a display device to a desired display area in a case where the maximum resolution of the display device is lower than the resolution of the overall image area. In this operation mode, when dragging is performed by a contact with an operation surface of an absolute coordinate type input device, the amount of movement by this operation is detected and the display area is moved on the display device. A stylus pen or a finger is used as dragging means. The user can operate the device utilizing a graphical user interface (GUI) while looking at information on the display screen.

When the GUI is operated by a stylus pen or a finger, the user operates the GUI with one hand, while holding the portable information device with the other hand. In this time, the user may operate the GUI by either the right hand or left hand, depending on, for example, whether the user is a right hander or left hander or whether the user is using the stylus pen or not. Therefore, the display of the same GUI to all users may cause inconvenience of operation for some users, and it has room for improvement

### BRIEF DESCRIPTION OF THE SEVERAL VIEWS OF THE DRAWINGS

A general architecture that implements the various feature of the invention will now be described with reference to the drawings. The drawings and the associated descriptions are provided to illustrate embodiments of the invention and not to limit the scope of the invention.

FIG. 1 is an exemplary front side perspective view of a portable device according to a first embodiment of the present invention;

FIG. 2 is an exemplary rear side perspective view of the portable device shown in FIG. 1;

FIG. 3 is an exemplary block diagram showing a system configuration of the portable device shown in FIG. 1;

FIG. 4 is an exemplary front view showing icons displayed on a liquid crystal display of the portable device shown in FIG. 1;

FIG. 5 is an exemplary front view showing a state of operating the icons shown in FIG. 4 with the right hand;

FIG. 6 is an exemplary flowchart showing a flow of calibration to adjust the positions of the icons shown in FIG. 4;

FIG. 7 is an exemplary front view showing a calibration screen displayed in the liquid crystal display in the calibration step shown in FIG. 6;

FIG. 8 is an exemplary front view showing a state in which a pen input device is removed from the casing of the portable device shown in FIG. 1;

FIG. 9 is an exemplary front view of the portable display device shown in FIG. 1, showing a process of moving icons from a first area to a second area by dragging;

FIG. 10 is an exemplary front view showing icons displayed on the liquid crystal display in a state where a portable device according to a second embodiment of the present invention is held by both hands; and

FIG. 11 is an exemplary front view showing icons displayed on the liquid crystal display in a state where a portable device according to a third embodiment of the present invention is held by both hands.

### DETAILED DESCRIPTION

Various embodiments according to the invention will be described hereinafter with reference to the accompanying drawings. In general, according to one embodiment of the invention, a portable device includes a casing; a display contained in the casing and having a first side in proximity to a position of the casing which is held by a user with a hand; a plurality of icons displayed on the display; a touch panel which is provided over the display and by which the icons are operated; and a sensor which is provided in the casing and senses the position held by the user. The icons are arranged in a first area defined by an arc of a circle about a first corner as a center located at a lower end of the first side, and chords extending between the arc and the first corner.

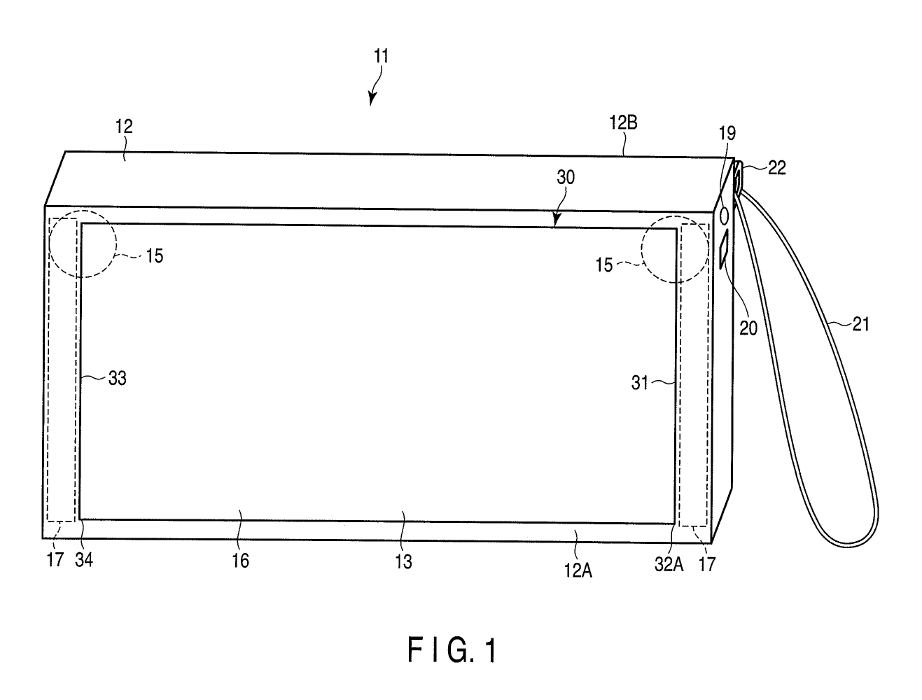

A portable device according to a first embodiment of the present invention will be described with reference to FIGS. 1 to 9.

A portable device 11 comprises a casing 12; a display, for example, a liquid crystal display 13, contained in the casing 12; a plurality of icons 14 displayed on the liquid crystal display 13; a speaker 15 contained in the casing 12; a touch panel 16 provided over the surface of the liquid crystal display 13; a pair of touch sensors 17 provided in the casing 12; a pen input device 18 to be brought into contact with the touch panel 16 to operate the icons 14 and the like; a jack 19 to which headphones can be attached; a USB connector 20 into which a counterpart connector is inserted; an attachment portion 22 to which a strap 21 is attached; and a finger hold portion 23 in which a finger is held when the user holds the casing 12. The portable device 11 further contains a printed circuit board 24 and a battery (not shown) inside the casing 12.

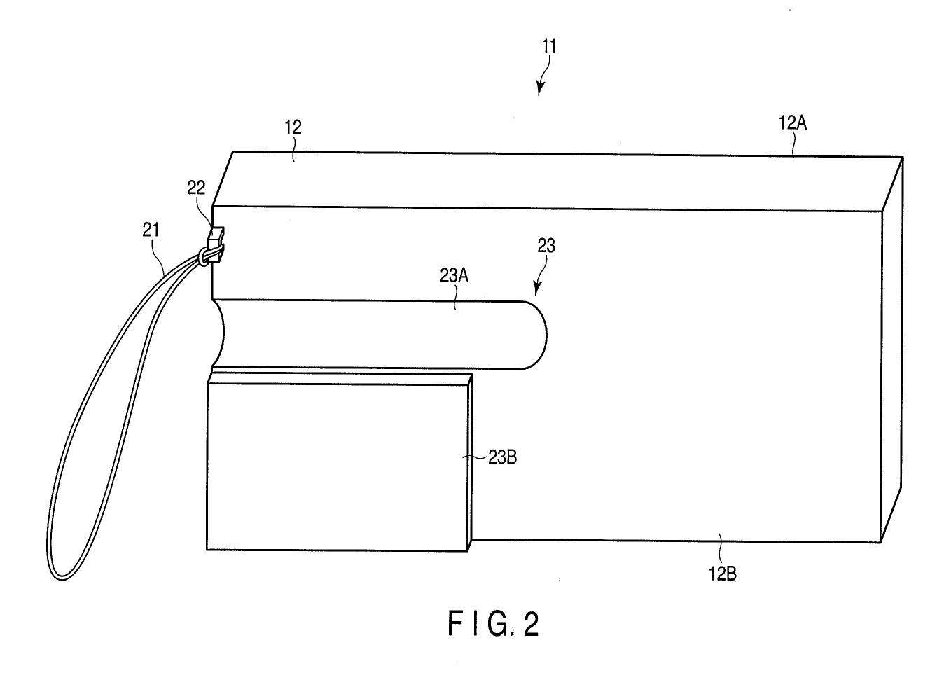

The touch panel 16, an example of pointing devices, is also called a tablet. The touch panel 16 is provided on the overall surface of the liquid crystal display 13, and allows the user to operate the icons 14 on the liquid crystal display 13 by touching it with a finger or the pen input device. The pen input device 18 is also called a stylus pen. The pen input device 18 is attached to the casing 12 in such a state that it is inserted in a recess formed in the casing 12. The portable device 11 further comprises a pen detection switch 29 provided on the bottom portion of the recess. The pen detection switch 29 is pushed down while the pen input device 18 is held in the recess. The pen detection switch 29 is an example of the detector to detect that the pen input device 18 is removed from the casing 12. When the pen input device 18 is removed, the pen detection switch 29 is pushed up. Thus, whether or not the pen input device 18 is removed from the housing is detected by means of the pen detection switch 29. In FIGS. 1 and 2, the pen input device 18 is omitted.

The casing 12 has a first surface 12A on which the liquid crystal display 13 is arranged, and a second surface 12B opposite to the first surface 12A. The casing 12 is made of, for example, a synthetic resin and shaped into a rectangular box. The first surface 12A of the casing 12 has a rectangular opening 30 to expose the liquid crystal display 13.

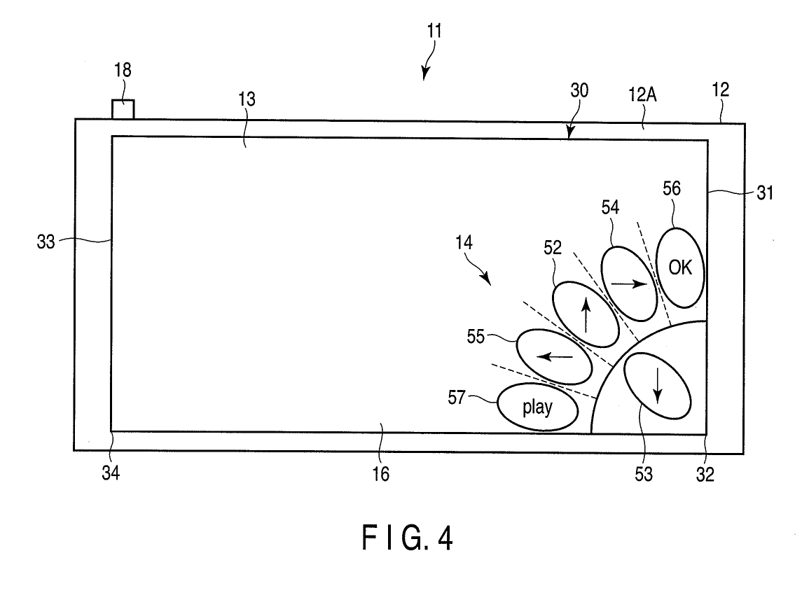

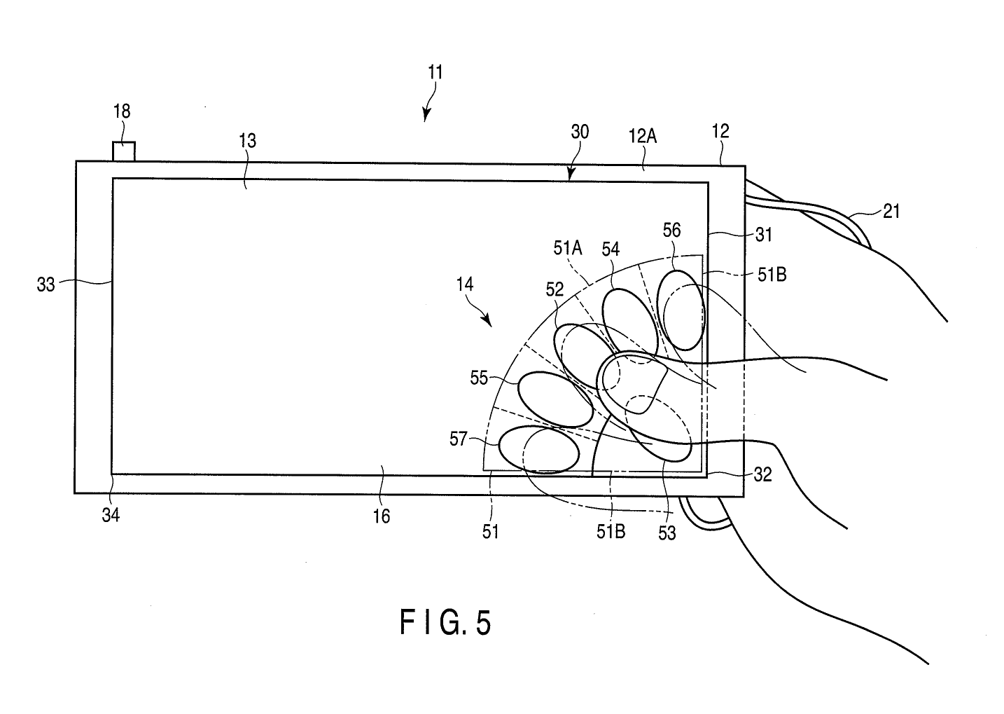

As shown in FIGS. 4 and 5, the liquid crystal display 13 has a first side 31 in proximity to that part of the casing 12 which is held by the user, a first corner 32 at the lower end of the first side 31, a second side 33 opposite to the first side 31 and a second corner 34 at the lower end of the second side 33. The first side 31, the first corner 32, the second side 33 and the second corner 34 represent relative positions, which vary depending on what part of the casing 12 the user holds. More specifically, FIGS. 4 and 5 show the state in which the user holds a right side of the casing 12 by the right hand; that is, the first side 31 is located on the right side. If the user holds a left side of the casing 12 by the left hand, the first side 31 is located on the left side.

The touch sensors 17 are an example of the sensors, and constituted by, for example, pressure sensitive sensors. The touch sensors 17 can sense what part of the casing 12 the user holds. The touch sensors 17 are not limited to the pressure sensitive sensors, but may be electrostatic sensors which detect electrostatic capacitance.

The attachment portion 22 is formed on the second surface 12B and at a position corresponding to the first side 31. More specifically, the attachment portion 22 is arranged in an upper portion of the side of the second surface corresponding to the first side 31. The strap 21 is attached to the attachment portion 22. The user uses the portable device 11 with a hand put through the strap 21. The finger hold portion 23 has a recess 23A configured to hold mainly an index finger, and a projection 23B formed below the recess 23A. The projection 23B also serves as a storage portion for a battery 102.

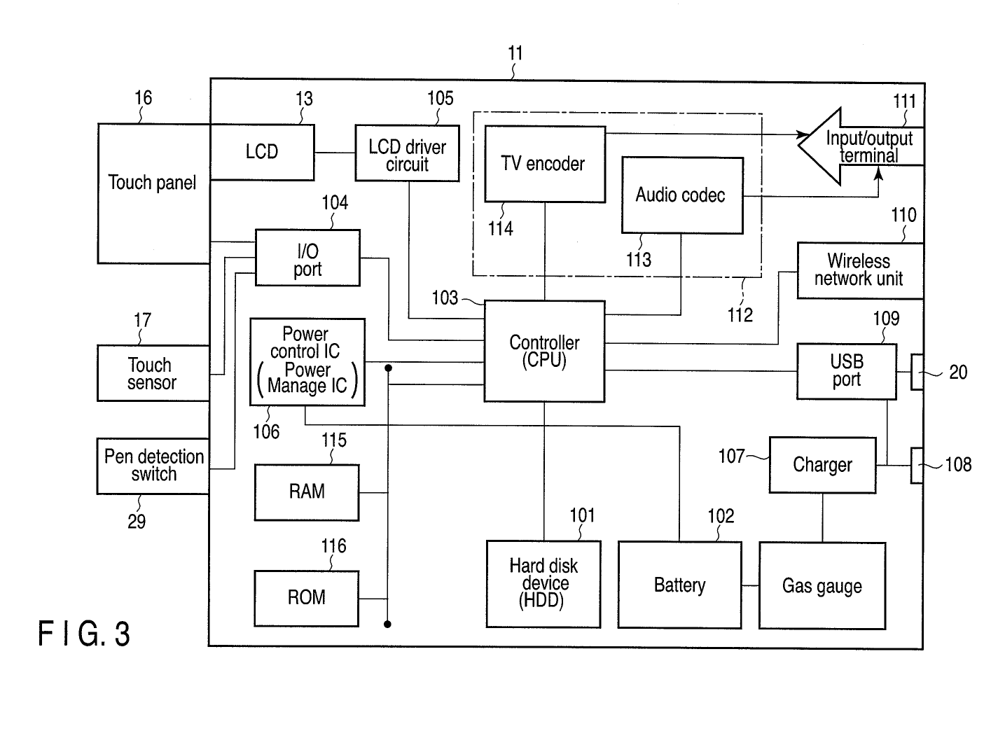

A system configuration of the portable device 11 will now be described with reference to FIG. 3.

FIG. 3 is a schematic block diagram for explaining a main configuration of the portable device, to which the embodiment of the present invention is applied and which is mainly used in a carried state.

The portable device (media player or music/image/video information recording and playback device) 11 shown in FIG. 3 includes the touch panel 16 for use in input of a control signal or an input of a selection instruction signal from the user; the LCD panel (liquid crystal display device) 13 capable of displaying, for example, the file name of a sound/music program currently being played back and character information contained in the sound program, or a moving image or still image produced by playing back image data; a hard disk device (HDD) 101 having a storage capacity of several or several tens of GB (gigabytes) of memory; a battery (secondary battery) 102 as a power source mainly used while the portable device is being carried; the touch sensors 17; the pen detection switch 29; and a main controller, i.e., a CPU 103. The HDD 101 may be a unitized body such as a “mobile disk”, SD/MMC memory card or memory stick, which can be removed from the portable device 11. The HDD 101 may be a Flash ROM or SSD (Solid State Disk).

The CPU 103 is connected to an I/O (input/output) port 104 which receives a control signal input by the user through an operation of the touch panel 16, a display driver (LCD driver circuit) 105 to display images and character strings on the LCD panel 13, an output section 112 which converts image data and sound/music data stored in the HDD 101 to an analog output, a power control IC (power management integrated circuit) 106 which manages power, i.e., a predetermined voltage supplied from the battery 102 and a permissible current, etc.

The power control IC 106 manages power, i.e., a predetermined voltage supplied from the battery 102 and a permissible current. The battery 102 is connected to a charger 107. The charger 107 may be configured to directly receive commercial power (AC 100V). However, generally, in this embodiment, a DC voltage, which has been reduced and converted to a direct current (DC) of about 5V, is input through a power input section 108 from an external power supply device (not shown) to make the portable device 11 compact.

The CPU 103 is further connected to a USB (universal serial bus) port 109 for use in exchange of data with, for example, a personal computer which is a supply source of image data (including character data) and music data (including sound data), a wireless network (wireless local area network) unit (communicating section) 110, an output terminal 111 for use in normal analog output, etc.

The USB port 109 is used to transfer music data (sound data) from the portable device 11 through the USB connector 20 to an external device, such as a playback device only for audio data (USB flash memory player) containing a semiconductor memory or to input a music/sound signal from a microphone (external input).

The wireless network unit 110 may be provided with only Bluetooth (registered trademark) in conformity with the protocol of the (high-speed) communication standard using the 2.4 GHz radio frequency bandwidth, or only a general-purpose wireless LAN device in conformity with IEEE802.11a/b/g. Needless to say, it may be provided with both. In other words, a wireless LAN device or Bluetooth incorporated in the portable device allows data exchange with a server computer or a personal computer located in home or a specific area that satisfies predetermined conditions.

The output terminal 111 for analog output is provided with music or sound as an analog signal demodulated by an audio codec 113 in the output section 112. Therefore, music or sound can be played back by attaching headphones or a speaker with an amplifier function to the output terminal 111. Needless to say, a higher-volume sound can be obtained by inputting the output from the output terminal 111 to an amplifier (not shown) and connecting a speaker (not shown) to the amplifier. It is possible to analog-to-digital convert an analog signal directly input from a microphone (not shown) or a line input (external input) terminal to a digital signal and input the digital signal to the audio coded 113.

The output terminal 111 is also connected with a video encoder 114 provided in the output section 112. With this configuration, image data stored in, for example, the HDD 101, can be transferred to a monitor or television receiver (not shown) and played back therein.

In the portable device 11 described above, the HDD 101 records contents such as music data, image data and video data, which have been compressed in advance, under a predetermined rule. As regards data compression, music data is compressed by, for example, MP3 (MPEG-1 audio layer 3) or WMA (Windows (registered trademark) Media Audio), image data is compressed by, for example, JPEG, GIF or BMP-RLE and video data is compressed by, for example, WMV (Windows Media Video) or MPEG. Though not described here in detail, the data may be stored in the HDD 101 in an encrypted format such that only direct playback by means of Player 1 or output as an analog signal to an external speaker is permitted, in order to prohibit duplication other than “private use” (duplication limited to a predetermined number of times) prescribed under the copyright law.

A multimedia data file of music data, video data or the like, stored in the HDD 101 is played back by playback software executed by the CPU 103. The recording format of a file, which the playback software according to this embodiment can play back, is limited to, for example, MP3, WMA and WMV.

The portable device can download a multimedia data file, such as a sound data file and an image data file published in a site on the Internet through the wireless network unit 110, and store it in the HDD 101. Then, it can play back the stored data.

FIG. 4 shows a state in which the user holds the right side of the casing 12 with the right hand. The hand of the user is sensed by the touch sensor 17 and a first area 51 (to be described later) is located in a right side portion of the liquid crystal display 13.

As shown in FIG. 4, the icons 14 include an up icon 52, a down icon 53, a right icon 54 and a left icon 55 to move a selected portion in a menu bar (not shown). The icons 14 also include an OK icon 56 to determine the item selected from the menu bar and a play icon 57 to play back music data or image data. The down icon 53 is located in proximity to the first corner 32 in the liquid crystal display 13. The up icon 52, the right icon 54, the left icon 55, the OK icon 56 and the play icon 57 are located farther from the first corner 32 than the down icon 53 and arranged radially about the first corner 32 as the center. Each of the icons 52 to 57 has an ellipse shape, so that the user can easily understand that it can be operated by a finger.

Further, as shown in FIG. 5, the icons 14 are located in the first area 51. The first area 51 is defined by an arc 51A, i.e. a segment of the circumference of a circle about the first corner 32 as the center, and chords 51B extending between the arc 51A and the first corner 32. The first area 51 corresponds to a range where the thumb of the hand which is holding the casing 12 can reach. The first area 51 is one area, which corresponds to one hand of the user, when the user is holding the casing 12 with the one hand.

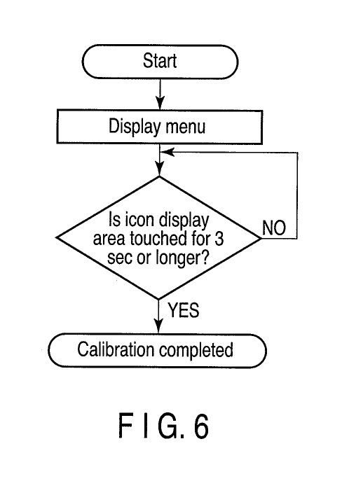

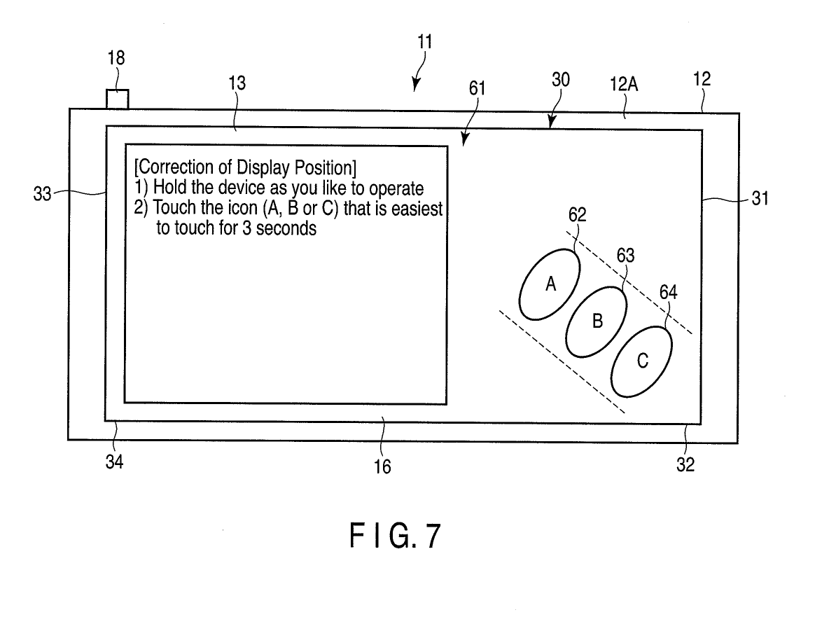

Calibration will now be described with reference to FIGS. 6 and 7. Calibration means adjustment of the positions of the icons 52 to 57 in the case where the positions of the icons 52 to 57 are not suitable. When the user starts calibration, a menu of a calibration screen 61 is first displayed on the liquid crystal display 13, as shown in FIGS. 5 and 6. For example, the menu reads as follows: “[Correction of Display Position] 1) Hold the device as you like to operate; 2) Touch the icon (A, B or C) that is easiest to touch for 3 seconds”.

If the user touches one of the icons 62, 63 and 64 (A, B and C) for three seconds or longer, the up icon 52, the right icon 54, the left icon 55, the OK icon 56 and the play icon 57 are arranged around the icon 62, 63 or 64. The up icon 52, the right icon 54, the left icon 55, the OK icon 56 and the play icon 57 are arranged radially about the first corner 32 as the center. The down icon 53 is arranged within an area surrounded by the up icon 52, the right icon 54, the left icon 55, the OK icon 56 and the play icon 57. Thus, the first area 51 can be scaled up or down in accordance of the length of the thumb of the user. Thus, the calibration is completed.

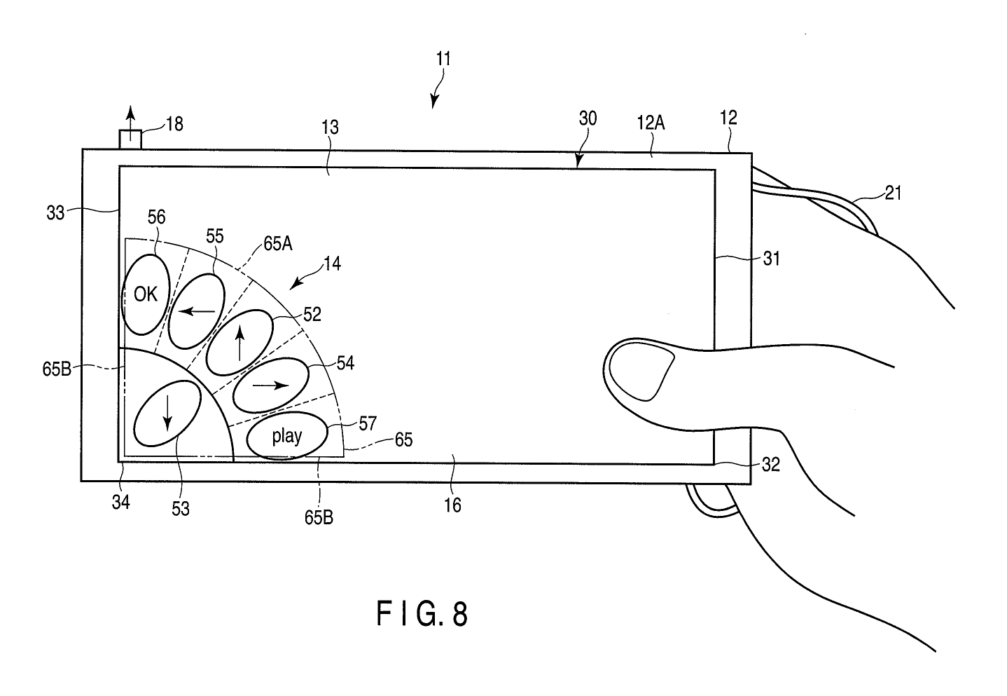

Movement of the icons 14 in the case where the pen input device 18 is removed from the casing 12 will now be described with reference to FIGS. 4 and 8. While the user is holding the casing 12 with the right hand, the icons 14 are arranged in the first area 51 in the right side as shown in FIG. 5. In this state, if the user pulls the pen input device 18 out of the casing 12 with the left hand, the pen detection switch 29 detects that the pen input device 18 has been removed from the casing 12. As a result, the icons 14 move to a second area 65 as shown in FIG. 8. In this time, the second area 65 is defined by an arc 65A, i.e. a segment of the circumference of a circle about the second corner 34 as the center at the lower end of the second side 33 opposite to the first side 31, and chords 65B extending between the arc 65A and the second corner 34. The movement of the icons 14 to the second area 65 causes the icons 14 located apart from the right hand. Thus, the user can easily operate the icons 14 with the pen input device 18.

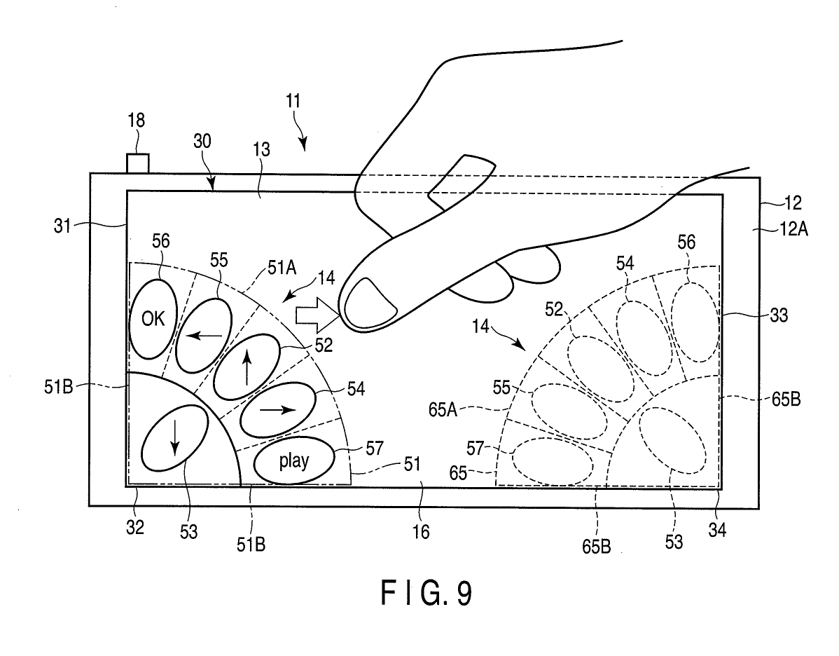

FIG. 9 shows a state in which the user holds the left side of the casing 12 with the left hand. In this time, the hand of the user is sensed by the touch sensor 17, and the first side 31, the first corner 32 and the first area 51 are located in a left side portion of the liquid crystal display 13. In this state, to locate the icons 14 in a right side portion, the user drags the portion of the touch panel 16 which corresponds to the first area 51 with a finger or the pen input device 18 to be located away from the first side 31. Accordingly, the icons 14 are moved to the second area 65 as indicated by the broken lines. In this time, the second area 65 is defined by an arc 65A, i.e. a segment of the circumference of a circle about the second corner 34 as the center at the lower end of the second side 33 opposite to the first side 31, and chords 65B extending between the arc 65A and the second corner 34.

Described above is the first embodiment of the portable device 11. According to the first embodiment, the portable device 11 comprises the casing 12; the display contained in the casing 12 and having the first side 31 located in proximity to that portion of the casing 12 which is held by the user; the icons 14 displayed on the display; the touch panel 16, which is provided over the surface of the display and by which the icons can be operated; and the sensor which is provided in the casing 12 and senses the position held by the user. The icons 14 are arranged in the first area 51 defined by the arc 51A, i.e. a segment of the circumference of a circle about the first corner 32 as the center located at the lower end of the first side 31, and chords 51B extending between the arc 51A and the first corner 32.

With this configuration, since the icons 14 are arranged near the portion which is held by the user, the user can operate the icons 14 with the hand holding the casing 12. Therefore, the operability of the icons 14 can be improved.

In this embodiment, the first area 51 corresponds to a range where the thumb of the hand holding the casing 12 can reach. With this configuration, the icons 14 can be easily operated by the thumb of the hand holding the casing 12. Therefore, the operability of the icons 14 can be improved.

In this embodiment, the first area 51 can be scaled up or down in accordance of the length of the thumb of the user. With this configuration, the icons 14 can be arranged in suitable positions in consideration of the difference in length of the thumb between men and women or between adults and children. Further, the first area 51 is one area, which corresponds to one hand of the user, when the user is holding the casing 12 with the one hand. With this configuration, the operability of the icons 14 can be improved when the user is holding the casing 12 with one hand.

In this embodiment, the user drags that portion of the touch panel 16 which corresponds to the first area 51 with a finger or the pen input device 18 in the direction away from the first side 31, with the result that the icons 14 are moved to the second area 65 defined by the arc 65A, i.e. a segment of the circumference of a circle about the second corner 34 as the center at the lower end of the second side 33 opposite to the first side 31, and the chords 65B extending between the arc 65A and the second corner 34. With this configuration, even if the icons 14 are arranged in a position undesirable for the user, the arrangement of the icons 14 can be easily corrected. Moreover, if the user passes the casing 12 from one hand to the other, the arrangement of the icons 14 can easily be corrected.

In this embodiment, the casing 12 has the first surface 12A on which the liquid crystal display 13 is arranged, and the second surface 12B opposite to the first surface 12A. The second surface 12B has a finger hold portion 23 in which a finger is held when the user holds the casing 12. With this configuration, the user can easily and securely hold the casing 12 with one hand. Further, in this embodiment, the second surface 12B has the attachment portion 22 to which the strap 21 is attached, so that a hand of the user is passed through the strap 21. This configuration allows the user to hold the casing 12 easier and more securely with one hand, and prevents the portable device 11 from being unintentionally dropped.

This embodiment further includes the pen input device 18, which is removably attached to the casing 12 and capable to operate the icons 14 via the touch panel 16, and the detecting portion, which is provided in the casing 12 and detects that the pen input device 18 has been removed from the casing 12. When the detecting portion detects removal of the pen input device 18, the icons 14 are moved to the second area 65 defined by the arc 65A, i.e. a segment of the circumference of a circle about the second corner 34 as the center at the lower end of the second side 33 opposite to the first side 31, and the chords 65B extending between the arc 65A and the second corner 34.

With this configuration, when the pen input device 18 is used, the icons 14 can be separated from the holding hand. Therefore, the operability of the icons 14 can be improved. Further, since the icons 14 are moved in association with the detecting portion, the arrangement of the icons 14 can be changed easily without any special operation.

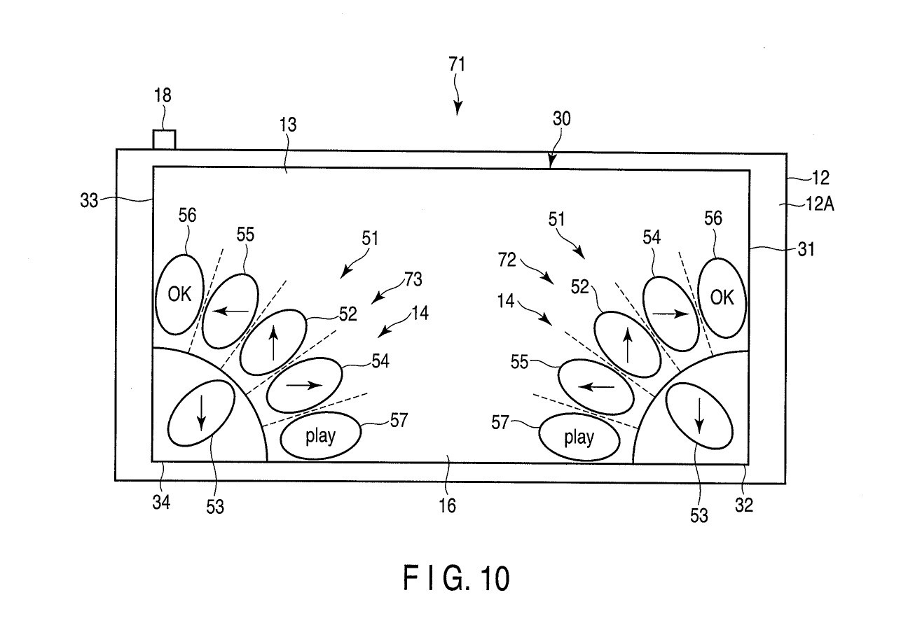

A second embodiment of the portable device 71 will now be described with reference to FIG. 10. A portable device 71 of the second embodiment differs from the first embodiment in that the casing 12 is held with both hands. It also differs from the first embodiment in arrangement of the icons 14. The other parts are the same as the corresponding parts of the first embodiment. Therefore, only the parts different from the first embodiment will be mainly described. The same parts are identified by the reference symbols which are assigned to the corresponding parts of the first embodiment, and the descriptions thereof are omitted.

FIG. 10 shows the icons 14 displayed when the casing 12 is held with both hands at both sides. The left and right hands of the user are sensed by the touch sensors 17. In this time, the icons 14 are arranged in the left and right sides of the liquid crystal display 13.

More specifically, first areas 51 located near the hands holding the casing 12 include a first portion 72 corresponding to the right hand of the user and a second portion 73 corresponding to the left hand of the user. The icons 14 are arranged in each of the first portions 72 and 73. The icons 14 arranged in the first portion 72 include an up icon 52, a down icon 53, a right icon 54, a left icon 55, an OK icon 56 and a play icon 57. The icons 14 arranged in the second portion 73 include an up icon 52, a down icon 53, a right icon 54, a left icon 55, an OK icon 56 and a play icon 57. Thus, in the second embodiment, the same kinds of icons 14 are arranged in the first portion 72 and the second portion 73.

According to the second embodiment, the casing 12 is held by the user with both hands. The first areas 51 have the first portion 72 corresponding to the right hand of the user and the second portion 73 corresponding to the left hand of the user, and the same kinds of icons 14 are arranged in the first portion 72 and the second portion 73. With this configuration, when the user uses the portable device, holding the casing 12 with both hands, the icons are arranged near both the left and right hands. Therefore, the operability of the icons 14 can be improved.

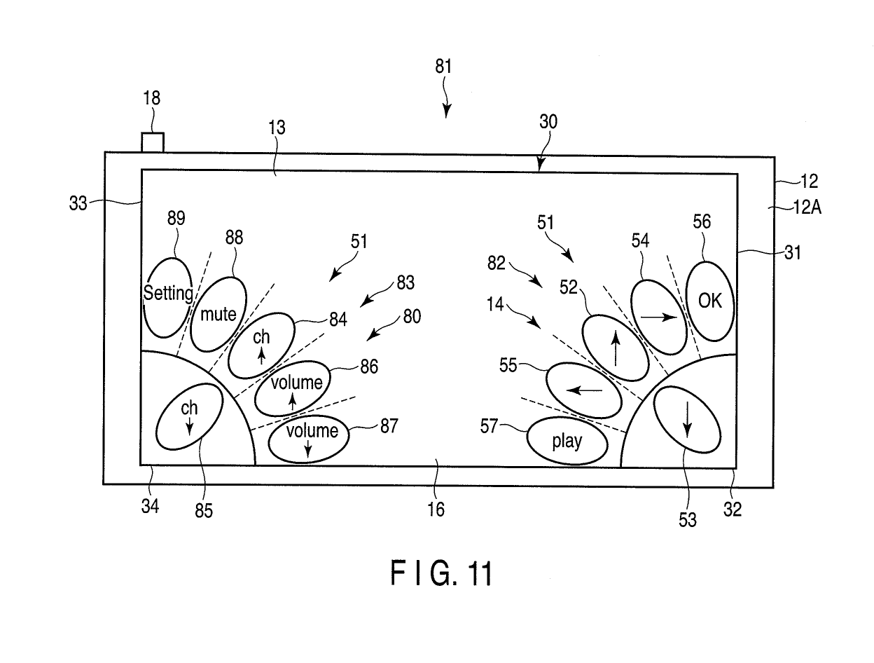

A third embodiment of a portable device 81 will be described with reference to FIG. 11. The portable device 81 of the third embodiment differs from the second embodiment in the kinds of displayed icons 14 and 80. The other parts are the same as the corresponding parts of the second embodiment. Therefore, only the parts different from the second embodiment will be mainly described. The same parts are identified by the reference symbols which are assigned to the corresponding parts of the second embodiment, and the descriptions thereof are omitted.

FIG. 11 shows the portable device 81 in the case where the sides of the casing 12 are held by both hands of the user. The left and right hands of the user are sensed by touch sensors 17. In this time, the icons 80 and 14 are respectively arranged in the left and right sides of the liquid crystal display 13.

First areas 51 located near the hands holding the casing 12 include a first portion 82 corresponding to the right hand of the user and a second portion 83 corresponding to the left hand of the user. The icons 14 are arranged in the first portion 82 and the icons 80 are arranged in the second portion 83. The icons 14 arranged in the first portion 82 include an up icon 52, a down icon 53, a right icon 54, a left icon 55, an OK icon 56 and a play icon 57. The icons 80 arranged in the second portion 83 include a channel up icon 84, a channel down icon 85, a volume up icon 86, a volume down icon 87, a mute icon 88 and a setting icon 89. The channel up icon 84 and the channel down icon 85 are used, for example, to change the channel of television displayed on the liquid crystal display 13.

The volume up icon 86 and the volume down icon 87 are used to turn up and down the volume, for example, when the user is playing back music. The mute icon 88 is used to mute the volume, for example, when the user is playing back music or watching television. The setting icon 89 is used to display, for example, a calibration screen 61 shown in FIG. 7. Thus, in the third embodiment, the different kinds of icons 14 and 80 are respectively arranged in the first portion 82 and the second portion 83.

According to the third embodiment, the casing 12 is held by the user with both hands. The first areas 51 have the first portion 82 corresponding to the right hand of the user and the second portion 83 corresponding to the left hand of the user, and the different kinds of icons 14 and 80 are respectively arranged in the first portion 82 and the second portion 83. With this configuration, when the user holds the casing 12 with both hands, the icons 80 and 14 are arranged near the left and right hands respectively. Further, since the icons 14 arranged near the right hand are different in kind from the icons 80 arranged near the left hand, various functions can be performed via the touch panel 16.

The portable devices 11, 71 and 81 of the present invention can be worked for other types of electronic device such as a cellular phone and a mobile computer. Further, the portable device can be variously modified without departing from the gist of the invention.

While certain embodiments of the inventions have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. A portable device comprising:
a casing;
a display in the casing comprising a first side;
a plurality of icons displayed on the display;
a touch panel above the display and by which the icons are operated; and
a touch-sensitive sensor in the casing configured to sense a depression on the casing,
wherein the icons are positioned in a first area defined by an arc and two sides of the display located at a lower end of a first corner of the display.

2. The portable device of claim 1, wherein the first area is corresponding to a reach of a thumb of a hand holding the casing.

3. The portable device of claim 2, wherein the first area is scaled up and down in accordance with a length of the thumb of the hand.

4. The portable device of claim 3, wherein the first area is one area which corresponds to the thumb of the hand.

5. The portable device of claim 4, wherein the icons are moved from the first area to a second area defined by an arc and two sides of the display located at a lower end of a second corner of the display corresponding to a sensed trajectory on the touch panel.

6. The portable device of claim 5, wherein the casing comprises a first surface on which the display is arranged and a second surface opposite to the first surface, the second surface comprising a finger hold portion to hold a finger.

7. The portable device of claim 6, wherein the second surface comprises an attachment portion to which a strap is attached, and the hand is passed through the strap.

8. The portable device of claim 4, further comprising:
a removable pen input device attached to the casing configured to operate the icons via the touch panel; and
a detecting portion in the casing configured to detect that the pen input device has been removed from the casing,
wherein the icons are moved to a second area defined by an arc and two sides of the display located at a second corner of the display, when the detecting portion detects removal of the pen input device.

9. The portable device of claim 8, wherein the casing comprises a first surface on which the display is arranged and a second surface opposite to the first surface, the second surface comprising a finger hold portion to hold a finger.

10. The portable device of claim 9, wherein the second surface comprises an attachment portion to which a strap is attached, and the hand is passed through the strap.

11. The portable device of claim 3, wherein:
the first area comprises a first portion corresponding to a first hand and a second portion corresponding to a second hand; and
the first portion and the second portion comprise a same set of the icons.

12. The portable device of claim 3, wherein:
the first area comprises a first portion and a second portion; and
the first portion comprises a first set of the icons and the second portion comprises a second set of the icons different from the first set of icons.
